(19) United States
(12) Patent Application Publication
(10) Pub. No.: US 2011/0148928 A1
(43) Pub. Date: Jun. 23, 2011

(54) SYSTEM AND METHOD TO CORRECT MOTION IN GATED-PET IMAGES USING NON-RIGID REGISTRATION

(75) Inventors: Girishankar Gopalakrishnan, Bangalore (IN); Rakesh Mullick, Bangalore (IN); Arunabha Shasanka Roy, Bangalore (IN); Sheshadri Rangarajan Thiruvenkadam, Bangalore (IN); Ravindra Mohan Manjeshwar, Glenville, NY (US)

(73) Assignee: GENERAL ELECTRIC COMPANY, SCHENECTADY, NY (US)

(21) Appl. No.: 12/640,207

(22) Filed: Dec. 17, 2009

(51) Int. Cl. G09G 5/00; G06K 9/00

(52) U.S. Cl. 345/643; 382/131; 382/294

(57) ABSTRACT

A method of imaging is presented. The method includes reconstructing image data acquired at a plurality of time intervals to obtain a plurality of images. Further, the method includes generating a mean image using the plurality of images. The method also includes correcting motion in the mean image or the plurality of images or both the mean image and the plurality of images by iteratively determining convergence of the mean image or the plurality of images or both the mean image and the plurality of images to generate a converged mean image, a converged plurality of images, or both a converged mean image and a converged plurality of images.

### BACKGROUND

Embodiments of the present invention relate generally to imaging and more particularly to correction of motion in gated images using non-rigid registration.

In modern healthcare facilities, non-invasive imaging systems are often used for identifying, diagnosing, and treating physical conditions. Medical imaging encompasses different non-invasive techniques used to image and visualize the internal structures and/or functional behavior (such as chemical or metabolic activity) of organs and tissues within a patient. Currently, a number of modalities of medical diagnostic and imaging systems exist, each typically operating on different physical principles to generate different types of images and information. These modalities include ultrasound systems, computed tomography (CT) systems, X-ray systems (including both conventional and digital or digitized imaging systems), positron emission tomography (PET) systems, single photon emission computed tomography (SPECT) systems, and magnetic resonance (MR) imaging systems.

PET images are commonly used for radiation therapy (RT) and radiation therapy planning (RTP). Generally, thoracic PET images are acquired over a time interval of several minutes. During this time, the patient typically undergoes motion due to respiration, cardiac motion and other gross patient movement. This motion results in blurring of a final image that is generated, consequently resulting in identification of an inaccurate planning tumor volume (PTV) in the blurred image. The inaccurate PTV may disadvantageously result in inaccurate detection of actual tumor regions and/or removal of normal tissue.

Currently available techniques address the problem associated with respiratory motion in PET imaging by breaking down a respiratory cycle into smaller time intervals via use of gating techniques and acquiring image data corresponding to these smaller time intervals. Although by employing these gating techniques the image data corresponding to the individual gates may be devoid of motion, each gate in isolation suffers from a low signal-to-noise ratio due to reduced photon counts recorded within a corresponding acquisition time interval. Furthermore, presence of motion due to patient breathing hinders assessment of nodules using chest scans in PET imaging, as the images acquired from different gates are not in alignment and this non-alignment of gated images is manifested as relative motion of the anatomical objects of interest between different images. Hence, accurate localization of tumors and their subsequent quantification from PET scans may not be achieved. Additionally, currently available techniques employ registration techniques to generate a final image, where an image corresponding to a particular gate is selected as a reference image and the other gated images are registered to the selected gated image. Use of a gated image as a reference image results in images being biased to the selected gated image. This bias hinders accurate determination of a tumor volume or an anomaly in a patient.

It is therefore desirable to develop a system and method for generating an image with enhanced signal-to-noise ratio that is devoid of motion effects caused due to patient movement such as respiratory or cardiac motion. More particularly, there is a need for a system and method for correcting motion in an image due to patient movement. Additionally, there is a need for a method of generating a final image that employs referenceless registration techniques to reduce any bias in the final image.

### BRIEF DESCRIPTION

In accordance with aspects of the present technique, a method of imaging is presented. The method includes reconstructing image data acquired at a plurality of time intervals to obtain a plurality of images. Further, the method includes generating a mean image using the plurality of images. The method also includes correcting motion in the mean image or the plurality of images or both the mean image and the plurality of images by iteratively determining convergence of the mean image or the plurality of images or both the mean image and the plurality of images to generate a converged mean image, a converged plurality of images, or both a converged mean image and a converged plurality of images.

In accordance with another aspect of the present technique, a method of imaging is presented. The method includes reconstructing image data acquired at a plurality of time intervals to obtain a plurality of images. In addition, the method includes generating a mean image using the plurality of images. The method also includes transforming the plurality of images by registering the plurality of images to the mean image to obtain a plurality of transformed images. Furthermore, the method includes generating an updated mean image using the plurality of transformed images. Also, the method includes correcting motion in the mean image or the plurality of images or the plurality of transformed images by iteratively determining convergence of the mean image or the plurality of images or the plurality of transformed images to generate a converged mean image, a converged plurality of images, or a converged plurality of transformed images.

In accordance with yet another aspect of the present technique, an imaging system is presented. The system includes a data acquisition system for acquiring image data at each of a plurality of time intervals. Moreover, the system includes a computer system for reconstructing the image data to obtain a plurality of images. Additionally, the system includes a motion correction subsystem for generating a mean image using the plurality of images, correcting motion in the mean image or the plurality of images or both the mean image and the plurality of images by iteratively determining convergence of the mean image or the plurality of images or both the mean image and the plurality of images to generate a converged mean image, a converged plurality of images, or both a converged mean image and a converged plurality of images, and a display device to display a motion corrected final image.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary PET imaging system, in accordance with aspects of the present technique;

FIG. 2 is a flowchart depicting an exemplary method of motion correction, in accordance with aspects of the present technique; and

FIG. 3 is a graphical illustration depicting convergence of gated images across iterations, in accordance with aspects of the present technique.

### DETAILED DESCRIPTION

Embodiments of the present invention generally relate to imaging. More particularly, embodiments of the present invention relate to motion correction in gated images using non-rigid registration. Though the present discussion provides examples in context of medical imaging systems and PET systems in particular, it may be noted that the present techniques may also be utilized for imaging systems such as ultrasound systems, computed tomography (CT) systems, X-ray systems, single photon emission computed tomography (SPECT) systems, and magnetic resonance (MR) imaging systems.

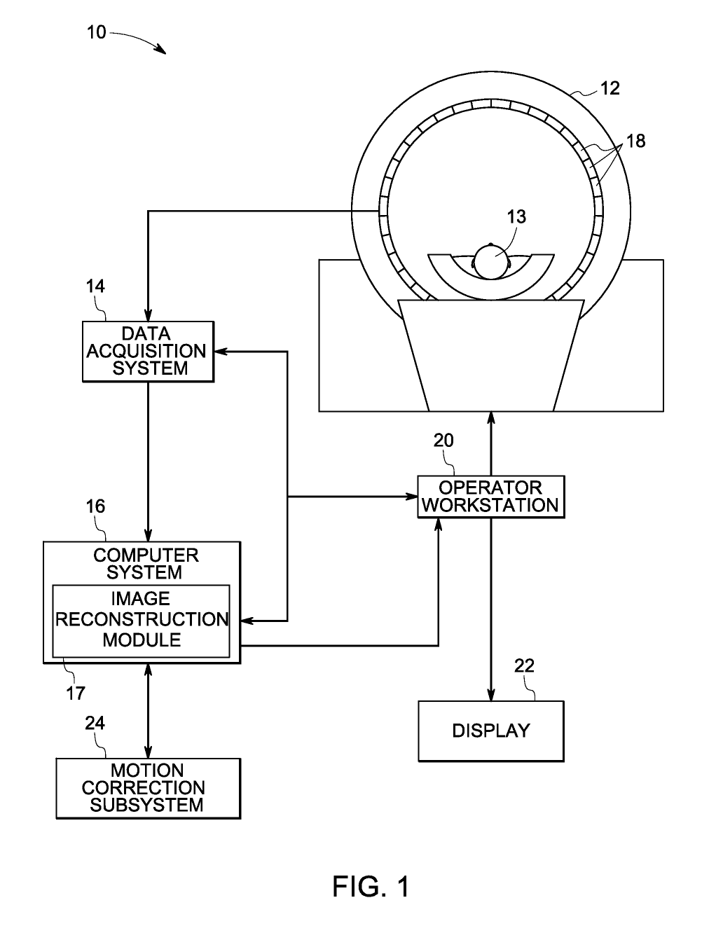

Referring now to FIG. 1, a diagrammatic illustration of an imaging system 10 for correcting motion in images is presented. In the illustrated embodiment, the system 10 is a positron emission tomography (PET) system designed to acquire tomographic data, reconstruct the tomographic data into an image, and process the image data for display and analysis, in accordance with the present technique. The PET system 10 includes a detector assembly 12, a data acquisition system 14, and a computer system 16. The detector assembly 12 typically includes a number of detector modules (generally designated by reference numeral 18) arranged in one or more rings, as depicted in FIG. 1. The PET system 10 also includes an operator workstation 20 and a display 22. While in the illustrated embodiment, the data acquisition system 14 and the computer system 16 are shown as being disposed outside the detector assembly 12 and the operator workstation 20, in certain other implementations, some or all of these components may be provided as part of the detector assembly 12 and/or the operator workstation 20. Each of the aforementioned components will be discussed in greater detail in the sections that follow.

In PET imaging, a patient 13 is typically injected with a solution that contains a radioactive tracer. The solution is distributed and absorbed throughout the body in different degrees depending on the tracer employed and the functioning of the organs and tissues in the patient 13. For instance, tumors typically process more glucose than a healthy tissue of the same type. Therefore, a glucose solution containing a radioactive tracer may be disproportionately metabolized by a tumor, allowing the tumor to be located and visualized by the radioactive emissions. In particular, the radioactive tracer emits particles known as positrons that interact with and annihilate complementary particles known as electrons to generate gamma rays. In each annihilation reaction, two gamma rays traveling in opposite directions are emitted. In the PET imaging system 10, the pair of gamma rays are detected by the detector assembly 12 configured to ascertain that two gamma rays detected sufficiently close in time are generated by the same annihilation reaction. Due to the nature of the annihilation reaction, the detection of such a pair of gamma rays may be used to determine a Line of Response (LOR) along which the gamma rays traveled before impacting the detector assembly 12, thereby allowing localization of the annihilation event to that line.

With continuing reference to FIG. 1, the data acquisition system 14 is adapted to read out signals generated in response to the gamma rays from the detector modules 18 of the detector assembly 12. For example, the data acquisition system 14 may receive sampled analog signals from the detector assembly 12 and convert the analog signals to digital signals for subsequent processing by the computer system 16. In certain embodiments, the computer system 16 may be coupled to the data acquisition system 14. The signals acquired by the data acquisition system 14 are communicated to the computer system 16 for further processing. Moreover, in certain embodiments, the computer system 16 may include an image reconstruction module 17 for reconstructing data acquired by the data acquisition system 14 to obtain an image. In a presently contemplated configuration, the computer system 16 is shown as including the image reconstruction module 17. However, in certain other embodiments, the image reconstruction module 17 may be separate from the computer system 16 and may be operationally coupled to the computer system 16.

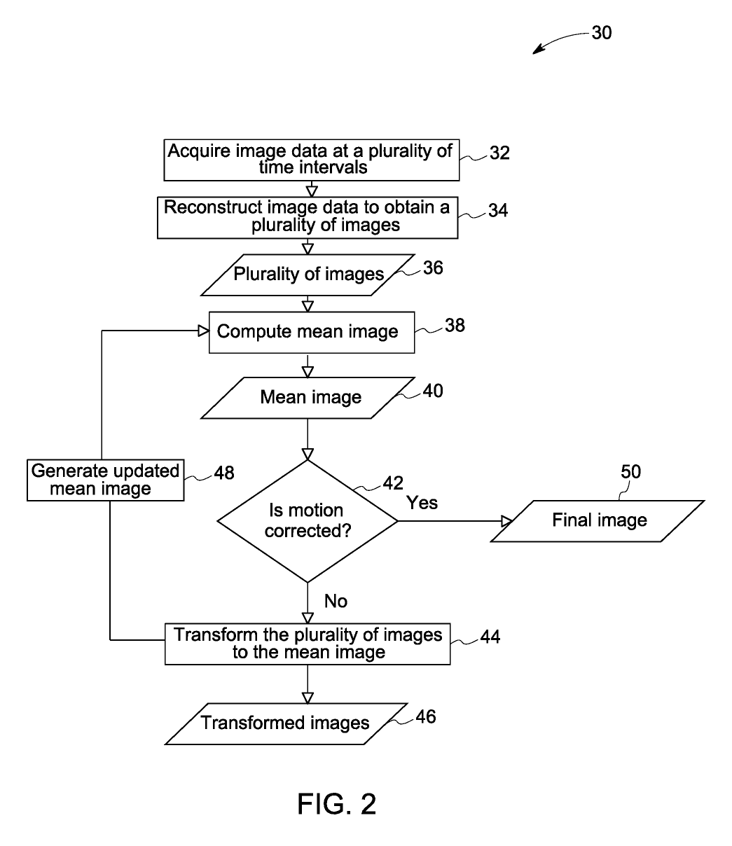

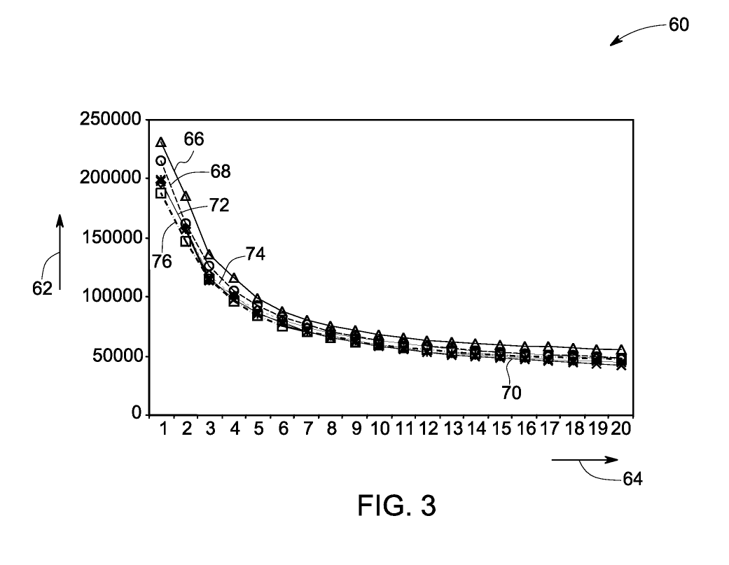

In accordance with aspects of the present technique, the PET imaging system 10 may also include an exemplary motion correction subsystem 24. The motion correction subsystem 24 may be configured to correct motion in gated PET images. As used herein, the term “gated images” is used to refer to images acquired at a plurality of time intervals. The working of the exemplary motion correction subsystem 24 will be described in greater detail with respect to FIGS. 2-3. In a presently contemplated configuration, the motion correction subsystem 24 is operationally coupled to the computer system 16. However, in another embodiment the motion correction subsystem 24 may be an integral part of the computer system 16. Furthermore, in yet another embodiment, the motion correction module 24 may be remotely coupled to the computer system 16.

Gated images may be acquired via use of gating devices (not shown in FIG. 1). In one embodiment, the gating device may be coupled to the data acquisition system 14 to acquire image data. Alternatively, the gating device may be an integral part of the data acquisition system 14. The image data thus acquired at a plurality of time intervals may be reconstructed by the computer system 16 to obtain a plurality of images. In one embodiment, the image data acquired at a plurality of time intervals may be reconstructed via the image reconstruction module 17 to generate the plurality of images. The operator workstation 20 may be utilized by a system operator to provide control instructions to some or all of the described components and for configuring the various operating parameters that aid in data acquisition and image generation. The display 22 coupled to the operator workstation 20 may be utilized to observe the reconstructed image. It may be further noted that the operator workstation 20 and the display 22 may be coupled to other output devices, which may include printers and standard or special purpose computer monitors. In general, displays, printers, workstations, and similar devices may be disposed in proximity to the PET system 10. However, the displays, the printers, the workstations, and other similar devices may be remote from the PET system 10, such as elsewhere within the institution or hospital, or in an entirely different location, and linked to the PET system 10 via one or more configurable networks, such as the Internet, virtual private networks, and the like.

Currently available reconstruction techniques typically generate a final image using a referenced registration. Particularly, in a referenced registration process an image corresponding to an individual gate is selected as a reference, and the other gated images are registered to the selected gated image. Unfortunately, this registration of other gated images to a selected reference gated image introduces a bias with respect to the selected gated image. Specifically, if the selected reference gate is of poor quality due to the presence of motion artifacts, images that are registered to the selected reference gate will reproduce such motion artifacts. In accordance with aspects of the present technique, an exemplary method of motion correction is presented that circumvents any bias by avoiding the selection of a particular gated image as a reference.

FIG. 2 is a flowchart 30 depicting an exemplary method of motion correction in gated images, in accordance with aspects of the present technique. More particularly, the exemplary method involves use of a referenceless non-rigid registration for motion correction in gated images. The exemplary method of motion correction includes reconstructing image data acquired at a plurality of time intervals to obtain a plurality of images, generating a mean image using the plurality of images, and correcting motion in the mean image, or the plurality of images, or both the mean image and the plurality of images. This is done by iteratively determining convergence of the mean image, or the plurality of images, or both the mean image and the plurality of images to generate a converged mean image, a converged plurality of images, or both a converged mean image and a converged plurality of images.

The method entails image acquisition at a plurality of time intervals. As previously noted, a gating device may be employed to acquire image data at the plurality of time intervals for imaging regions such as the heart, the lungs, the breast and upper abdominal sites to obtain a plurality of gated images. The gated images may be obtained by employing gating techniques such as, but not limited to, a phase-gating technique, an amplitude-gating technique, or a combination thereof.

Accordingly, as depicted in FIG. 2, the method starts at step 32 where the image data is acquired at a plurality of time intervals. The acquired image data is reconstructed employing image reconstruction techniques, as indicated by step 34. In accordance with aspects of the present technique, image reconstruction techniques such as, but not limited to, an iterative image reconstruction technique or a filtered backprojection technique may be employed to facilitate the reconstruction of the acquired image data. A plurality of images 36 may be obtained by applying image reconstruction techniques to the acquired image data. In one embodiment, the image reconstruction module 17 (see FIG. 1) may be used to reconstruct image data acquired by the data acquisition system 14 (see FIG. 1) to generate the plurality of images 36. It may be noted that motion in the patient 13 (see FIG. 1) and/or motion due to organ movement in the patient 13, such as, movement of lungs due to breathing during acquisition of the plurality of images 36, may result in motion effects in an image that is reconstructed using the plurality of images 36.

Accordingly, this plurality of images 36 may be processed to facilitate correction of any motion effects from the plurality of images 36. The images so processed may then be employed to generate a final image that is motion corrected. As used herein, the term “motion corrected” may be used to refer to correction of any motion effects in images. Also, the terms “motion corrected” and “motion compensated” may be used interchangeably. To that end, in accordance with aspects of the present technique, a mean image 40 may be computed using the plurality of images 36, as indicated by step 38. In one embodiment, the mean image 40 may be computed by averaging pixel intensities in the plurality of images 36. As used herein, the term “averaging the plurality of images” may be used to refer to computation of a mean, a median or a mode of the pixel intensities in the plurality of images 36 to obtain the mean image 40. In an alternative embodiment, the mean image 40 may be computed by computing an arithmetic mean of the pixel intensities in the plurality of images 36. It may be noted that the motion correction subsystem 24 (see FIG. 1) may be employed to generate the mean image 40.

As previously noted, the plurality of images 36 may include motion effects due to any patient motion and/or organ movement in the patient. Accordingly, at step 42, a determination is made as to whether motion effects due to either patient motion or organ movement, for example, are present in either the plurality of images 36 or in the mean image 40 or in both the plurality of images 36 and the mean image 40. In one embodiment, the presence of motion effects in the plurality of images 36 or the mean image 40 may be verified by comparing each of the gated images, such as, the plurality of images 36, with the mean image 40.

More particularly, in one embodiment, each of the plurality of images 36 may be compared with the mean image 40 via use of a registration metric. In accordance with aspects of the present technique, the registration metric may include a mean square error metric, a mutual information metric, or a correlation metric. In certain other embodiments, a combination of the mean square error metric, the mutual information metric and the correlation metric may also be used. By way of example, if the registration metric includes a mean square error metric, a mean square error value corresponding to each of the plurality of images 36 may be calculated. It may be noted that a mean square error value corresponding to each of the plurality of images 36 may be representative of a difference in intensity between a corresponding image 36 and the mean image 40. Furthermore, at step 42, if the mean square error value corresponding to each of the plurality of images 36 is less than a determined threshold value, it may be inferred that the plurality of images 36 are motion corrected. Subsequently, the plurality of images 36 that are motion corrected may be employed to generate a motion corrected final image 50.

However, at step 42, if it is determined that the plurality of images 36 include motion effects, the plurality of images 36 may be further processed to further diminish the presence of motion effects in the plurality of images 36. Particularly, if the mean square error value corresponding to at least one image in the plurality of images 36 is greater than the determined threshold value, then, in accordance with aspects of the present technique, the plurality of images 36 may be transformed to the mean image 40, as depicted by step 44. Specifically, the plurality of images 36 may be transformed by registering each of the plurality of images 36 with the mean image 40. In one embodiment, each of the plurality of images 36 may be registered with the mean image 40 via a use of non-rigid registration technique. Accordingly, this exemplary method of registering the plurality of images 36 with the mean image 40 may also be referred to as a referenceless non-rigid registration method as the method does not entail selection and use of a particular gated image as a reference. In an alternative embodiment, each of the plurality of images 36 may be registered with the mean image 40 using a rigid registration technique. Consequent to this transformation at step 44, a plurality of transformed images 46 may be obtained. In certain embodiments, the motion correction subsystem 24 may be configured to determine the mean square error values corresponding to each of the plurality of images 36 and facilitate generation of the plurality of transformed images 46.

Subsequent to the generation of the plurality of transformed images at step 44, an updated mean image may be computed using the plurality of transformed images 46, as depicted by step 48. Accordingly, the mean image 40 may now be representative of the updated mean image. This updated mean image generated at step 48 may be referred to as an “evolving” mean image as the updated mean image is generated using the plurality of transformed images 46, which in turn is generated by registering the plurality of images 36 to the mean image 40.

A check may again be carried out to determine whether motion effects are present in the plurality of transformed images 46, as depicted by decision block 42. Specifically, in one embodiment, the determination of presence of motion effects in the plurality of transformed images 46 may be achieved by computing a mean square error value corresponding to each of the plurality of transformed images 46. The mean square error value corresponding to each of the plurality of transformed images 46 may be representative of a difference in intensity between a corresponding transformed image 46 and the updated mean image. Furthermore, if the mean square error value corresponding to each of the plurality of transformed images 46 is less than a determined threshold value, then it may be inferred that the transformed images 46 are now motion corrected. This plurality of transformed images 46 and/or a corresponding updated mean image may be used to generate a motion corrected final image 50.

However, at step 42, if it is determined that the mean square error value corresponding to at least one of the plurality of transformed images 46 is greater than the determined threshold value, then it may be inferred that the plurality of transformed images 46 are not totally motion corrected. Accordingly, steps 40-48 may be iteratively repeated until the mean square error value corresponding to the plurality of transformed images 46 is less than the determined threshold value. The plurality of transformed images 46 having corresponding mean square error values that are less than the determined threshold value may be employed to generate the final motion corrected image 50.

In accordance with other aspects of the present technique, rather than iterating based on the mean square error value, steps 40-48 may simply be performed iteratively for a set number of iterations. By way of example, steps 40-48 may be performed for N iterations. A plurality of transformed images generated at the N^{th} iteration may be employed to reconstruct the final motion corrected image 50, for example.

Furthermore, in accordance with other aspects of the present technique, the updated mean image may be checked for presence of motion effects. Specifically, the presence of motion effects in the updated mean image may be checked by comparing a mean image generated at a current iteration (an N^{th} iteration) with a corresponding mean image generated at a previous iteration (an (N−1)^{th} iteration). By way of example, the current iterate of the mean image may include the updated mean image generated using the plurality of transformed images 46, while the previous iterate of the mean image may include the mean image 40 generated using the plurality of images 36. In the present example, a mean square error value corresponding to the updated mean image may be computed. The mean square error value may be representative of a difference in intensity between the updated mean image and the mean image 40. If the computed mean square error value is less than the determined threshold value, then it may be inferred that the updated mean image is motion corrected. The updated mean image may be representative of the motion corrected final image 50 or may be used to generate the motion corrected final image 50.

However, if the mean square error value is greater than the determined threshold value, then it may be inferred that the updated mean image is not totally motion corrected. Accordingly, steps 40-48 may be iteratively repeated until the mean square error value corresponding to the updated mean image is less than the determined threshold value. Here again, rather than iterating based on the mean square error value, steps 40-48 may simply be performed iteratively for a set number of iterations (for example N iterations) and the updated mean image generated at the N^{th} iteration may be used to generate the final image or may be representative of the final motion corrected image 50.

In accordance with yet another aspect of the present technique, determination as to whether motion effects are present may be accomplished by comparing images generated at a current iteration (N^{th} iteration) with corresponding images generated at a previous iteration ((N−1)^{th} iteration). By way of example, the current iterate of the images may include the plurality of transformed images 46, while the previous iterate of the images may include the plurality of images 36. Specifically, a mean square error value corresponding to each of the plurality of transformed images 46 may be computed. The mean square error value may be representative of a difference in intensity between each of the plurality of transformed images 46 and a corresponding image 36. If the computed mean square error value corresponding to each of the plurality of transformed images 46 is less than a determined threshold value, then it may be inferred that the plurality of transformed images 46 is motion corrected. The plurality of transformed images 46 may be used to generate the motion corrected final image 50.

However, if the mean square error value of at least one of the plurality of transformed images 46 is greater than the determined threshold value, then it may be inferred that the plurality of transformed images 46 is not totally motion corrected. Accordingly, steps 40-48 may be iteratively repeated until the mean square error value corresponding to each of the plurality of transformed images 46 is less than the determined threshold value. Alternatively, steps 40-48 may be performed iteratively for a set number of iterations.

Additionally, in accordance with further aspects of the present technique, at step 42, motion correction in gated PET images may also be verified based upon convergence of the plurality of images 36 and/or the convergence of the mean image 40. As used herein, the plurality of images are said to be “converged” if a difference between mean square error values corresponding to a current iterate of the plurality of images and mean square error values corresponding to a previous iterate of the plurality of images is less than a determined threshold value. Specifically, if the mean square error values determined at the current iteration (the N^{th} iteration, for example) is substantially similar to the mean square error values determined at the previous iteration (the (N−1)^{th} iteration) or if the difference between the mean square error values corresponding to the current iterate and the previous iterate is less than the determined threshold value, it may be inferred that the images corresponding to the current iteration and those corresponding to the previous iteration have “converged.” This convergence may be representative of motion correction in the images corresponding to the current iteration. These converged transformed images corresponding to the current iteration may then be employed to generate the final image 50, where the final image 50 is representative of a motion corrected image. However, if convergence is not achieved, steps 40-48 may be iteratively repeated until convergence is achieved.

In yet another embodiment, presence of motion effects may be checked by comparing a current iterate of the mean image with a previous iterate of the mean image. By way of example, the mean image obtained at the N^{th} iteration may be compared with the mean image obtained at the (N−1)^{th} iteration to check for correction of motion effects. Accordingly, if the mean square error value corresponding to the current iterate (the N^{th} iteration) of the mean image and the mean square error value corresponding to the previous iterate (the (N−1)^{th} iteration) of the mean image are substantially similar or if the difference between the mean square error values corresponding to the current iterate and the previous iterate of the mean image is less than the determined threshold value, then it may be inferred that the mean image has converged. The converged mean image may be representative of a motion corrected final image or may be employed to generate the motion corrected final image. Moreover, in accordance with further aspects of the present techniques, determination of presence of motion effects in the plurality of transformed images 46 may be accomplished by comparing each of the plurality of transformed images 46 with a previous iterate of a corresponding transformed image.

With continuing reference to FIG. 2, the final image 50 is motion corrected and has enhanced image quality as the final image 50 is generated using the plurality of transformed images (converged transformed images) and/or the updated mean image (converged updated mean image) that are corrected for motion effects. More particularly, the exemplary method of motion correction eliminates a bias towards a particular reference gated image by registering each of the gated images to the evolving mean image, thereby minimizing motion effects in the final image 50. The generation of the motion corrected final image 50 in turn facilitates accurate determination of any anomalies in the object of interest. It may be noted that in certain embodiments the motion correction subsystem 24 may be employed to perform steps 32-50 of FIG. 2. Further, the final image 50 thus generated may be displayed on the display device 22 of FIG. 1.

Implementing the method of motion correction as described hereinabove, a motion corrected final image having enhanced image quality may be obtained. Moreover, speed of convergence may be substantially enhanced as the evolving image is used to check for correction of motion.

FIG. 3 is a graphical illustration 60 depicting convergence of the gated images, such as the plurality of images 36 of FIG. 2, in accordance with the exemplary method described with reference to FIG. 2. As previously noted, convergence is said to be achieved if the mean square error values corresponding to each of the plurality of images do not change significantly in subsequent iterations. Alternatively, the verification for convergence may be achieved by performing a set number of iterations. In the example presented in FIG. 3, a fixed number of iterations are performed to achieve convergence. It may be noted that the Y-axis 62 is representative of mean square error values whereas the X-axis 64 is representative of a number of iterations. In the present example, a gating device that is configured to acquire image data at six time intervals is employed. The image data obtained at each of the six gates may be reconstructed to obtain six gated images. Reference numerals 66, 68, 70, 72, 74 and 76 are representative of a first curve, a second curve, a third curve, a fourth curve, a fifth curve and a sixth curve respectively depicting the mean square error value corresponding to each of the six gated images I_{K} where K=1 to 6 at each iteration.

As illustrated by the first curve 66 in FIG. 3, for a first gated image I₁, the mean square error value is about 240000 in the first iteration. The mean square error value decreases to a value of about 180000 at the second iteration as depicted after applying the exemplary motion correction method described with reference to FIG. 2. Moreover, the mean square error value corresponding to the first gated image I₁ decreases to about 60000 at about the thirteenth iteration. Also, the mean square error value corresponding to the first gated image I₁ does not change substantially in iterations subsequent to the thirteenth iterations, thereby depicting convergence.

Additionally, as depicted by curves 68, 70, 72, 74 and 76 in FIG. 3, the mean square error value corresponding to each of the gated images decreases with each iteration and attains a substantially similar value at around the thirteenth iteration. Additionally, these mean square error values do not change substantially in subsequent iterations, thereby indicating convergence. By way of example, the mean square error value corresponding to each of the six gated images decreases to a value of about 60000 at about the thirteenth iteration and does not change in subsequent iterations thereby converging to a substantially similar value.

The system and method of motion correction in gated PET images as described hereinabove have several advantages such as elimination of bias towards a particular gate image. As a result, an image with enhanced image quality is obtained as compared to images generated via use of other methods that select an individual gate as a reference. Further, the exemplary method of motion correction results in a final image that is corrected for patient motion such as a respiratory motion between the gates. A reference-free non-rigid registration method for aligning and combining PET image information obtained from multiple gates across a respiratory cycle is presented. This method generates a final “mean image” in which the image blur is reduced while improving the signal-to-noise ratio (SNR). Moreover, the exemplary method entails iterative joint estimation of the mean image and the non-rigid transformation of the different gate images towards the evolving mean. Additionally, the method of motion correction may be configured to enhance speed of convergence as compared to the conventional methods that involve registering to an individual gate chosen as the reference image. Moreover, the present method by foregoing the choice of any single gate as a reference, treats all gates equally and thereby is unbiased.

Furthermore, improved speed of achieving convergence may be obtained using the exemplary method as the method circumvents the need for selection of a reference gate. Moreover, the exemplary method of motion correction entails combination of information corresponding to one or more gates to produce a mean image. This improves the photon count statistics used to generate the final image and also contributes to increased signal-to-noise ratio. In addition, this information-rich mean image is then used for image registration.

The method also enhances reduction of noise in PET images. Noise models may also be incorporated during the registration process described for the exemplary method, wherein the evolving mean image may be considered to be noise-less and the images obtained at a plurality of gates may have a Poisson-like distribution of noise. Particularly, the exemplary method may be extended to model the noise in PET by a Poisson or alternative physical model signal. Modeling the noise using information from PET image information provides an estimate of the true signal.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of imaging, comprising:
reconstructing image data acquired at a plurality of time intervals to obtain a plurality of images;
generating a mean image using the plurality of images; and
correcting motion in the mean image or the plurality of images or both the mean image and the plurality of images by iteratively determining convergence of the mean image or the plurality of images or both the mean image and the plurality of images to generate a converged mean image, a converged plurality of images, or both a converged mean image and a converged plurality of images.

2. The method of claim 1, wherein generating the mean image comprises averaging the plurality of images.

3. The method of claim 1, wherein generating the mean image comprises calculating an arithmetic mean of the plurality of images.

4. The method of claim 1, wherein iteratively determining convergence of the mean image comprises transforming the plurality of images by registering the plurality of images to the mean image to obtain a plurality of transformed images.

5. The method of claim 4, wherein registering the plurality of images comprises use of a non-rigid registration technique.

6. The method of claim 4, further comprising generating an updated mean image using the plurality of transformed images.

7. The method of claim 6, wherein iteratively determining convergence of the mean image comprises comparing a current iterate of the mean image with a previous iterate of the mean image.

8. The method of claim 7, wherein iteratively determining convergence of the plurality of images comprises comparing the current iterate of each of the plurality of images with a corresponding previous iterate.

9. The method of claim 8, wherein iteratively determining convergence of the mean image or the plurality of images comprises use of a registration metric.

10. The method of claim 9, wherein the registration metric comprises a mean square error metric, a mutual information metric, a correlation metric, or combinations thereof.

11. The method of claim 6, wherein iteratively determining convergence of the mean image further comprises:
transforming the plurality of images to the updated mean image to obtain a plurality of new transformed images; and
generating a new mean image using the plurality of new transformed images.

12. The method of claim 11, wherein transforming the plurality of images to the updated mean image comprises registering the plurality of images to the updated mean image.

13. The method of claim 12, further comprising generating a motion corrected final image employing the converged updated mean image, the converged plurality of images, or both the converged updated mean image and the converged plurality of images.

14. The method of claim 13, further comprising displaying the motion corrected final image on a display.

15. A method of imaging, comprising:
reconstructing image data acquired at a plurality of time intervals to obtain a plurality of images;
generating a mean image using the plurality of images;
transforming the plurality of images by registering the plurality of images to the mean image to obtain a plurality of transformed images;
generating an updated mean image using the plurality of transformed images; and
correcting motion in the mean image or the plurality of images or the plurality of transformed images by iteratively determining convergence of the mean image or the plurality of images or the plurality of transformed images to generate a converged mean image, a converged plurality of images, or a converged plurality of transformed images.

16. The method of claim 15, further comprising generating a motion corrected final image employing the converged mean image, the converged plurality of images, the converged plurality of transformed images, or combinations thereof.

17. The method of claim 16, further comprising displaying the motion corrected final image on a display.

18. An imaging system, comprising:
a data acquisition system for acquiring image data at each of a plurality of time intervals;
a computer system for reconstructing the image data to obtain a plurality of images;
a motion correction subsystem for:
generating a mean image using the plurality of images;
correcting motion in the mean image or the plurality of images or both the mean image and the plurality of images by iteratively determining convergence of the mean image or the plurality of images or both the mean image and the plurality of images to generate a converged mean image, a converged plurality of images, or both a converged mean image and a converged plurality of images; and
a display device to display a motion corrected final image.

19. The imaging system of claim 18, wherein the motion correction subsystem is configured to compare a current iterate of the mean image with a previous iterate of the mean image.

20. The imaging system of claim 19, wherein the motion correction subsystem is further configured to compare the current iterate of the mean image with the previous iterate of the mean image via use of a registration metric.

21. The imaging system of claim 18, wherein the motion correction subsystem is configured to compare the current iterate of the plurality of images with a corresponding previous iterate of the plurality of images via use of the registration metric.

22. The imaging system of claim 21, wherein the registration metric comprises a mean square error metric, a mutual information metric, a correlation metric, or combinations thereof.

23. The imaging system of claim 18, wherein the motion correction subsystem is configured to generate the motion corrected final image employing the converged mean image, the converged plurality of images, or both the converged updated mean image and the converged plurality of images.

24. The imaging system of claim 18, wherein the imaging system comprises a positron emission tomography system, a computed tomography system, a single photon emission computed tomography system, a magnetic resonance imaging system, or combinations thereof.
